(19) United States
(12) Patent Application Publication
(10) Pub. No.: US 2026/0193817 A1
(43) Pub. Date: Jul. 9, 2026

(54) WASTE TEXTILE OPENER AND CONTROL METHOD

(71) Applicant: QINGDAO HONGDA TEXTILE MACHINERY CO., LTD., Qingdao (CN)

(72) Inventors: Wenxin ZHANG, Qingdao (CN); Zhonghao CUI, Qingdao (CN); Jingda NI, Qingdao (CN); Zhongtao LI, Qingdao (CN); Jun ZHANG, Qingdao (CN); Huachun ZHAN, Qingdao (CN); Yong WANG, Qingdao (CN)

(21) Appl. No.: 19/551,376

(22) Filed: Feb. 26, 2026

Related U.S. Application Data
(63) Continuation of application No. PCT/CN2024/104660, filed on Jul. 10, 2024.

(30) Foreign Application Priority Data
Apr. 2, 2024 (CN) 202410394013.5

(51) Int. Cl. D01G 11/04

(52) U.S. Cl. CPC D01G 11/04

(57) ABSTRACT

A waste textile opener includes a housing, a cotton feeding plate, a cotton feeding roller, a safety cover plate, an opening beater, an output apparatus, an adjustable grid, and a control system. The output apparatus includes a raw material channel, a fan, a carding wire plate, a negative pressure cover, an air return pipe, and a diffusion box. The raw material channel communicates with an air outlet port of the diffusion box, the bottom of an outlet end of the raw material channel communicates with the top of the negative pressure cover, and the negative pressure cover successively communicates with the fan and the diffusion box. The control system controls an opener set formed by at least two openers, each opener having a modular structure, and the outlet end of the raw material channel in a preceding opener configured for connecting to a next opener.

### TECHNICAL FIELD

The present invention belongs to the technical field of textile machinery manufacturing and relates to improvements in opening machines, specifically a waste textile opening machine and a control method thereof.

### BACKGROUND

An opening machine is primarily used to open fibers, cotton, textiles, and other materials by tearing large fabric pieces into smaller fragments or bundles, with the opening process simultaneously achieving a separating effect.

As illustrated in FIG. 2, the existing waste textile opening machine comprises a cotton feeding board 1, feeding roller 2, opening beater 3, safety cover plate 4, adjustable grid bars 13, rotary dust cage 14, output roller 16, and support roller 17. The rotary dust cage 14 is equipped with a dust filtration groove 15. Its output mechanism relies on the rotary dust cage 14 to condense the opened fibers, which is then discharged via the output roller 16.

The existing opening machine presents the following key challenges:
1. The machine requires both a dust cage and an output roller motor, while the dust cage necessitates additional dust filtration and exhaust systems, resulting in a complex structure and a higher failure rate.
2. After the opening machine outputs the semi-finished product, the material condensed by the dust cage tends to tangle and wrap, complicating subsequent opening processes and causing repeated fiber and yarn opening, which leads to fiber damage.
3. The feeding section at the connection of the opening machine group lacks sufficient power, making the feeding roller prone to jamming.
4. The one-sided suction of the dust cage causes uneven material width distribution, leading to inconsistent opening in the next stage.
5. Both the output and feeding mechanisms of the opening machine feature open structures, which can result in fiber spray, shorten the machine cleaning cycle, and increase the workload for operators.

The critical technical challenge is to design a waste textile opening machine and control method that replaces the existing dust cage and output roller mechanism with an airflow-based output device, seamlessly integrating it with the opening machine. This design should feature a simple, compact, and well-sealed structure, ensuring stable and reliable operation, high automation, and enhanced production efficiency. Solving this problem is an urgent priority in the field.

### SUMMARY

To address the issues and deficiencies existing in the prior art, the present invention provides a waste textile opening machine and a control method thereof.

The invention utilizes an airflow-type output device to replace the dust cage and output roller mechanism found in conventional opening machines. This device is integrated into the opening machine, resulting in a structure that is simple and compact, with a high degree of automation and production efficiency. Furthermore, the control method ensures the stable and continuous operation of the output device.

A waste textile opening machine, comprising: a machine housing; a feeding board; feeding rollers; an opening beater; a safety cover plate; an output device; adjustable grid bars; and a control system; wherein the output device comprises a material channel, a fan, a pin plate, a suction hood, a return air pipe, and a diffusion box; an inlet end of the material channel is positioned below the opening beater and is in fluid communication with an outlet of the diffusion box; an outlet end of the material channel is connected to a top of the suction hood; a side of the suction hood is connected to a return air inlet of the fan via the return air pipe; a blowing outlet of the fan is connected to an air inlet of the diffusion box; the control system controls an opening machine group comprising at least two opening machines; each of the at least two opening machines in the opening machine group has a modular structure; and the outlet end of the material channel in a preceding opening machine of the opening machine group is configured to connect to a subsequent opening machine.

As a further improvement, the material channel comprises a tapering section extending from the inlet end to a middle portion thereof, the tapering section having a gradually decreasing cross-section, and an adjustable section extending from the middle portion to the outlet end, the adjustable section having a variable height; the pin plate is disposed at a bottom of the adjustable section of the material channel, and the top of the suction hood encloses the pin plate; the return air pipe is a Y-shaped conduit comprising a single inlet connected to the return air inlet of the fan and dual outlets respectively connected to opposite sides of the suction hood; the diffusion box is a labyrinth-style diffusion box comprising internal baffles forming a Z-shaped channel, wherein a cross-section of the labyrinth-style diffusion box narrows progressively in a direction of airflow to reach a minimum cross-section at the outlet thereof; and the fan is configured to blow air into the material channel through the labyrinth-style diffusion box to generate air pressure for propelling opened fibers into a subsequent opening machine, while suction from the fan draws airflow discharged from the pin plate through the suction hood to establish a circulating airflow.

As a further improvement, the opening machine comprises a pressure sensor disposed on the material channel, wherein the pressure sensor is connected to the control system; wherein the pressure sensor is configured to continuously monitor internal pressure of the material channel; and wherein the control system is configured to dynamically adjust a rotational speed of the feeding rollers based on the monitored internal pressure to maintain uniform and stable material feeding.

As a further improvement, a material thickness adjustment device is disposed at a top of the adjustable section of the material channel, the material thickness adjustment device comprising a material thickness detection sensor, an adjustment motor, an adjustment plate, guide keys, racks, gears, and a transmission shaft ; the material thickness detection sensor is installed above the feeding rollers and connected to the control system; the adjustment plate forms an adjustable top surface of the adjustable section, wherein each side of the adjustment plate is fitted with a support plate; each support plate is provided with a vertical hole at a center thereof and a guide slot on each side of the vertical hole; the transmission shaft extends through the vertical holes of both support plates; the adjustment motor is mounted on the machine housing and has an output shaft connected to one end of the transmission shaft ; one of the gears is installed at each end of the transmission shaft and engages with the racks disposed on each side, wherein each rack is fixed to an inner side of the corresponding support plate; and each guide slot contains one of the guide keys, and each guide key is secured to the machine housing.

As a further improvement, a front end of the pin plate is wider than a cross-section of the material channel; a rear end of the pin plate is narrower than the cross-section of the material channel; and the pin plate is configured with a tapered design to ensure uninterrupted material transfer within the material channel.

As a further improvement, the outlet end of the material channel extends outside the machine housing; a bottom height of the outlet end of the material channel is aligned with a bottom height of the feeding rollers; in the opening machine group, the outlet end of the material channel in the preceding opening machine is connected to the feeding rollers of the subsequent opening machine; and the input and output of each of the opening machines in the opening machine group form a fully enclosed structure.

The other aspect of the present invention provides a control method for a waste textile opening machine, the waste textile opening machine being the waste textile opening machine as described above, the control method comprising a pressure control method for a material channel comprising the following steps:
Step S1: setting, by a control system, a preset pressure value; acquiring, by the control system, an actual pressure value detected by a pressure sensor inside the material channel; and determining a pressure deviation between the preset pressure value and the actual pressure value; and
Step S2: calculating and adjusting, by the control system, a feeding speed of feeding rollers by employing a PID control algorithm based on the pressure difference;
wherein, if the actual pressure value exceeds the preset pressure value, the control system reduces the feeding speed of the feeding rollers; and
wherein, if the actual pressure value is below the preset pressure value, the control system increases the feeding speed of the feeding rollers to maintain uniform and stable material feeding.

Further, the method comprises an input material thickness control method, comprising the following steps:
Step 1: setting, by the control system, a preset material thickness value; detecting, by the control system via the material thickness detection sensor, an actual material thickness value of material input from a preceding opening machine; and calculating a thickness difference between the actual material thickness value and the preset material thickness value; and
Step 2: adjusting, by the control system, a thickness of the material channel of the preceding opening machine by applying a PID control algorithm to drive the adjustment motor of the material thickness adjustment device based on the thickness difference; wherein, if the actual material thickness value exceeds the preset material thickness value, the material thickness adjustment device automatically reduces the thickness of the material channel; and
wherein, if the actual material thickness value is below the preset material thickness value, the material thickness adjustment device automatically increases the thickness of the material channel.

Compared with the prior art, the advantages and positive effects of the present invention are as follows:
1. The output device for the waste textile opening machine of the present invention replaces the dust cage and output roller mechanism of conventional opening machines. By utilizing airflow output, the structure is simplified, compact, and demonstrates stable and reliable operation.
2. The opening machine employs pneumatic pressure feeding, ensuring that the thickness and width of the fed raw materials remain stable.
3. The input and output of the opening machine are fully enclosed, reducing lint/fiber spray and keeping the machine clean and orderly.
4. The machine utilizes a pressure sensor to control the feed roller. Furthermore, the output device is equipped with a material thickness adjustment device, which automatically regulates the thickness of the raw materials to ensure the continuity and automation of the entire opening line.
5. The machine adopts a modular design, allowing the number of units to be flexibly configured based on different raw materials and production processes.

### DESCRIPTION OF DRAWINGS

FIG. 1 is a schematic structural diagram showing the connection of an opening machine group consisting of two waste textile opening machines of the present invention;

FIG. 2 is a schematic structural diagram of a conventional opening machine group;

FIG. 3 is a schematic diagram of the output device used in the waste textile opening machine of the present invention;

FIG. 4 is a schematic diagram of the material thickness adjustment device used in the waste textile opening machine of the present invention;

FIG. 5 is a schematic diagram of the needle comb plate used in the waste textile opening machine of the present invention.

### REFERENCE NUMERALS

1. Feed plate; 2. Feed roller; 3. Opening beater; 4. Safety guard; 5. Pressure sensor; 6. Material thickness adjustment device; 61. Adjustment motor; 62. Adjustment plate; 63. Racks; 64. Guide keys; 65. Gears; 66. Transmission shaft; 7. Pin plate; 8. Material thickness detection sensor; 9. Suction hood; 10. Return air pipe; 11. Fan; 12. Diffusion box; 13. Adjustable grid bars; 14. Rotary dust cage; 15. Dust filtration groove; 16. Output roller; 17. Support roller.

### DETAILED DESCRIPTION

The invention is further described in detail below with reference to the accompanying drawings:

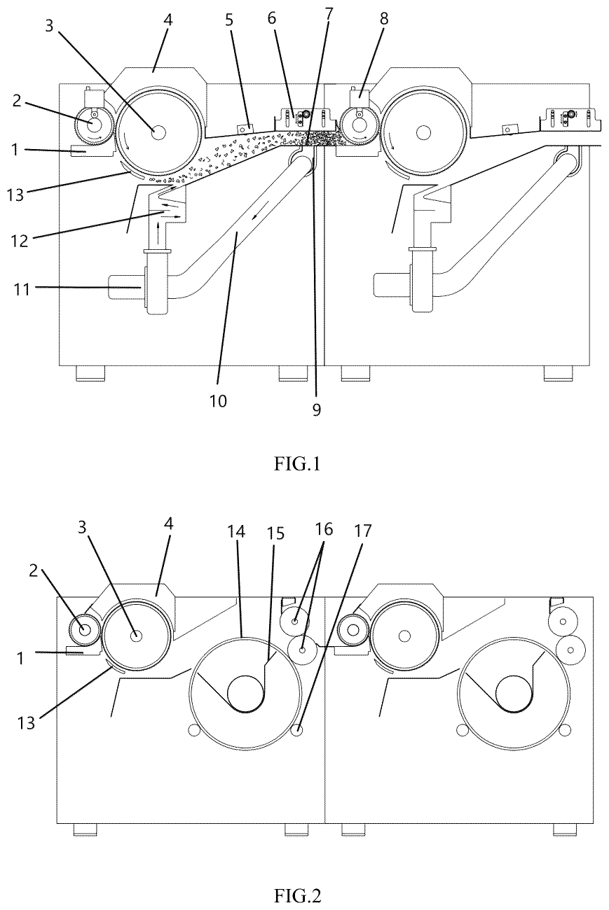

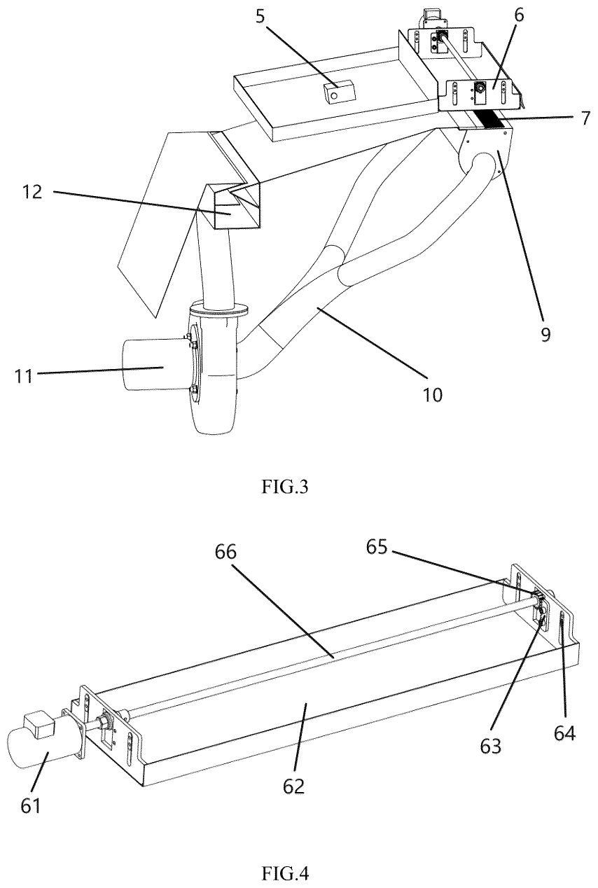

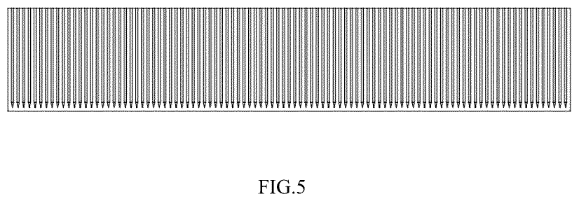

As shown in FIGS. 1-5, an embodiment of the waste textile opening machine according to the invention comprises a machine housing, a feeding board 1, feeding rollers 2, an opening beater 3, a safety cover plate 4, an output device, adjustable grid bars 13, and a control system. The output device includes a material channel, a fan 11, a pin plate 7, a suction hood 9, a return air pipe 10, and a diffusion box 12.

The inlet end of the material channel is positioned below the opening beater 3 and is in fluid communication with the outlet of the diffusion box 12. The outlet end of the material channel is connected to the top of the suction hood 9, while the side of the suction hood 9 is connected to the return air inlet of the fan 11 via the return air pipe 10. The blowing outlet of the fan 11 is connected to the air inlet of the diffusion box 12.

The control system controls an opening machine group comprising at least two opening machines. Each opening machine in the group has a modular structure, and the outlet end of the material channel in the preceding opening machine is designed to connect to the subsequent opening machine.

The material channel features a tapering section extending from the inlet end to the middle portion thereof, the tapering section having a gradually decreasing cross-section, and an adjustable section extending from the middle portion to the outlet end, the adjustable section having a variable height. The pin plate 7 is disposed at a bottom of the adjustable section of the material channel, and the top of the suction hood 9 encloses the pin plate 7. The return air pipe 10 is designed as a Y-shaped conduit, comprising a single inlet connected to the return air inlet of the fan 11 and dual outlets connected to opposite sides of the suction hood 9. The diffusion box 12 is a labyrinth-style diffusion box with internal baffles, forming a Z-shaped channel. The cross-section of the labyrinth-style diffusion box 12 narrows progressively in the direction of airflow, reaching its smallest cross-section at the outlet. The fan 11 is configured to blow air into the material channel through the labyrinth-style diffusion box 12, generating air pressure to propel the opened fibers into the subsequent opening machine. Simultaneously, the suction generated from the fan 11 extracts airflow discharged from the pin plate 7 via the suction hood 9, establishing a circulating airflow.

Additionally, the material channel is provided with a pressure sensor 5, which is connected to the control system. The pressure sensor 5 continuously monitors the internal pressure of the material channel, which is used to dynamically adjust the rotational speed of the feeding rollers 2 to maintain uniform and stable material feeding.

Moreover, a material thickness adjustment device is disposed at the top of the adjustable section of the material channel. The material thickness adjustment device 6 comprises a material thickness detection sensor 8, an adjustment motor 61, an adjustment plate 62, racks 63, guide keys 64, gears 65, and a transmission shaft 66. The material thickness detection sensor 8 is installed above the feeding rollers 2 and connected to the control system. The adjustment plate 62 forms the adjustable top surface of the adjustable section. Each side of the adjustment plate 62 is fitted with a support plate, each of the support plates is provided with a vertical hole at the center and a guide slot on either side of the vertical hole. The transmission shaft 66 extends through the vertical holes of both support plates. The adjustment motor 61, mounted on the machine housing, has its output shaft connected to one end of the transmission shaft 66. The gear 65 is installed at each end of the transmission shaft 66, engaging with the rack 63 on each side. Each rack 63 is fixed to the inner side of the support plate. Each of the guide slots contains one of the guide keys 64, which is secured to the machine housing.

Furthermore, the front end of the pin plate 7 is wider than the cross-section of the material channel, while the rear end of the pin plate 7 is narrower than the cross-section of the material channel. This tapered design ensures smooth and uninterrupted material transfer within the material channel.

Furthermore, the outlet end of the material channel extends outside the machine housing, with its bottom height aligned with that of the feeding rollers 2. In the opening machine group, the outlet end of the material channel in the preceding opening machine is connected with the feeding roller 2 of the subsequent opening machine. This arrangement ensures that the input and output of each opening machine in the group form a fully enclosed structure, optimizing material flow and operational efficiency.

As shown in FIGS. 1-5, an embodiment of the control method for the waste textile opening machine, as described in the present invention, utilizes the aforementioned waste textile opening machine. The control method incorporates a pressure control method for the material channel, with the following specific steps:
Step S1: The control system sets a preset pressure value, acquires the actual pressure value detected by the pressure sensor 5 inside the material channel and determines the pressure deviation between the preset pressure value and the actual pressure value.
Step S2: Based on the pressure deviation, the control system employs a PID control algorithm to dynamically regulate the feeding speed of the feeding rollers 2. If the actual pressure value exceeds the preset value, the control system reduces the feeding speed of the feeding rollers 2. If the actual pressure value is below the preset value, the control system increases the feeding speed of the feeding rollers 2.

The control method also includes an input material thickness control method, with the following specific steps:
Step 1: The control system initializes a preset material thickness value, acquires the actual material thickness value of the material fed from the preceding opening machine via the material thickness detection sensor 8, and calculates the thickness deviation between the actual material thickness value and preset material thickness value.
Step 2: Based on the calculated deviation, the control system utilizes a PID control algorithm to regulate the thickness of the material channel by driving the adjustment motor 61 of the material thickness adjustment device 6 of the preceding opening machine. If the actual material thickness value exceeds the preset value, the material thickness adjustment device automatically reduces the thickness of the material channel. If the actual material thickness value is below the preset value, the material thickness adjustment device automatically increases the thickness of the material channel.

The above description is not intended to limit the invention. The invention is not limited to the examples provided. Ordinary skilled persons in the technical field can make various modifications, changes, additions, or replacements within the scope of the invention. These variations should also fall within the protection scope of the invention.

1. A waste textile opening machine, comprising:
a machine housing;
a feeding board;
feeding rollers;
an opening beater;
a safety cover plate;
an output device;
adjustable grid bars; and
a control system;
wherein the output device comprises a material channel, a fan, a pin plate, a suction hood, a return air pipe, and a diffusion box;
an inlet end of the material channel is positioned below the opening beater and is in fluid communication with an outlet of the diffusion box;
an outlet end of the material channel is connected to a top of the suction hood;
a side of the suction hood is connected to a return air inlet of the fan via the return air pipe;
a blowing outlet of the fan is connected to an air inlet of the diffusion box;
the control system controls an opening machine group comprising at least two opening machines;
each of the at least two opening machines in the opening machine group has a modular structure; and
the outlet end of the material channel in a preceding opening machine of the opening machine group is configured to connect to a subsequent opening machine.

2. The opening machine of claim 1, wherein:
the material channel comprises a tapering section extending from the inlet end to a middle portion thereof, the tapering section having a gradually decreasing cross-section, and an
adjustable section extending from the middle portion to the outlet end, the adjustable section having a variable height;
the pin plate is disposed at a bottom of the adjustable section of the material channel, and the top of the suction hood encloses the pin plate;
the return air pipe is a Y-shaped conduit comprising a single inlet connected to the return air inlet of the fan and dual outlets respectively connected to opposite sides of the suction hood;
the diffusion box is a labyrinth-style diffusion box comprising internal baffles forming a Z-shaped channel, wherein a cross-section of the labyrinth-style diffusion box narrows progressively in a direction of airflow to reach a minimum cross-section at the outlet thereof, and the fan is configured to blow air into the material channel through the labyrinth-style diffusion box to generate air pressure for propelling opened fibers into a subsequent opening machine, while suction from the fan draws airflow discharged from the pin plate through the suction hood to establish a circulating airflow.

3. The opening machine of claim 1, further comprising a pressure sensor disposed on the material channel, wherein the pressure sensor is connected to the control system;
wherein the pressure sensor is configured to continuously monitor internal pressure of the material channel; and
wherein the control system is configured to dynamically adjust a rotational speed of the feeding rollers based on the monitored internal pressure to maintain uniform and stable material feeding.

4. The opening machine of claim 3, wherein:
a material thickness adjustment device is disposed at a top of the adjustable section of the material channel, the material thickness adjustment device comprising a material thickness detection sensor, an adjustment motor, an adjustment plate, guide keys, racks, gears, and a transmission shaft;
the material thickness detection sensor is installed above the feeding rollers and connected to the control system;
the adjustment plate forms an adjustable top surface of the adjustable section, wherein each side of the adjustment plate is fitted with a support plate;
each support plate is provided with a vertical hole at a center thereof and a guide slot on each side of the vertical hole;
the transmission shaft extends through the vertical holes of both support plates;
the adjustment motor is mounted on the machine housing and has an output shaft connected to one end of the transmission shaft;
one of the gears is installed at each end of the transmission shaft and engages with the racks disposed on each side, wherein each rack is fixed to an inner side of the corresponding support plate; and
each guide slot contains one of the guide keys, and each guide key is secured to the machine housing.

5. The opening machine of claim 2, wherein:
a front end of the pin plate is wider than a cross-section of the material channel;
a rear end of the pin plate is narrower than the cross-section of the material channel; and
the pin plate is configured with a tapered design to ensure uninterrupted material transfer within the material channel.

6. The opening machine of claim wherein:
the outlet end of the material channel extends outside the machine housing;
a bottom height of the outlet end of the material channel is aligned with a bottom height of the feeding rollers;
in the opening machine group, the outlet end of the material channel in the preceding opening machine is connected to the feeding rollers of the subsequent opening machine; and
the input and output of each of the opening machines in the opening machine group form a fully enclosed structure.

7. The opening machine of claim 3, wherein:
the outlet end of the material channel extends outside the machine housing;
a bottom height of the outlet end of the material channel is aligned with a bottom height of the feeding rollers;
in the opening machine group, the outlet end of the material channel in the preceding opening machine is connected to the feeding rollers of the subsequent opening machine; and
the input and output of each of the opening machines in the opening machine group form a fully enclosed structure.

8. The opening machine of claim 4, wherein:
the outlet end of the material channel extends outside the machine housing;
a bottom height of the outlet end of the material channel is aligned with a bottom height of the feeding rollers;
in the opening machine group, the outlet end of the material channel in the preceding opening machine is connected to the feeding rollers of the subsequent opening machine; and
the input and output of each of the opening machines in the opening machine group form a fully enclosed structure.

9. A control method for a waste textile opening machine, the waste textile opening machine being the waste textile opening machine as claimed in claim 3, the control method comprising a pressure control method for a material channel comprising the following steps:
Step S1: setting, by a control system, a preset pressure value; acquiring, by the control system, an actual pressure value detected by a pressure sensor inside the material channel; and determining a pressure deviation between the preset pressure value and the actual pressure value; and
Step S2: calculating and adjusting, by the control system, a feeding speed of feeding rollers by employing a PID control algorithm based on the pressure difference;
wherein, if the actual pressure value exceeds the preset pressure value, the control system reduces the feeding speed of the feeding rollers; and
wherein, if the actual pressure value is below the preset pressure value, the control system increases the feeding speed of the feeding rollers to maintain uniform and stable material feeding.

10. The control method of claim 8, further comprising an input material thickness control method, comprising the following steps:
Step 1: setting, by the control system, a preset material thickness value; detecting, by the control system via the material thickness detection sensor, an actual material thickness value of material input from a preceding opening machine; and calculating a thickness difference between the actual material thickness value and the preset material thickness value; and
Step 2: adjusting, by the control system, a thickness of the material channel of the preceding opening machine by applying a PID control algorithm to drive the adjustment motor of the material thickness adjustment device based on the thickness difference;
wherein, if the actual material thickness value exceeds the preset material thickness value, the material thickness adjustment device automatically reduces the thickness of the material channel; and
wherein, if the actual material thickness value is below the preset material thickness value, the material thickness adjustment device automatically increases the thickness of the material channel.
